(19) United States
(12) Patent Application Publication
(10) Pub. No.: US 2004/0179026 A1
(43) Pub. Date: Sep. 16, 2004

(54) Method for laying out arbitrary shape images in a given space

(76) Inventor: Malcolm Rix, Taipei (TW)

Correspondence Address: BIRCH STEWART KOLASCH & BIRCH, PO BOX 747, FALLS CHURCH, VA, 22040-0747, US

(21) Appl. No.: 10/396,313

(22) Filed: Mar. 26, 2003

(30) Foreign Application Priority Data
Mar. 14, 2003 (TW) 92105585

(51) Int. Cl. G09G 5/00

(52) U.S. Cl. 345/660

(57) ABSTRACT

A method for laying out arbitrary shape rectangular images in a given rectangular space. The images are in an order. The method comprises steps of implementing a binary search for an optimal scale factor applied to all the images, for which there is only one of a first and second layout of the images fit to the space and identified as an optimal layout, and placing on the space by the optimal layout the images to which the optimal scale factor is applied. The first and second layout are generated by two different layout algorithms.

### BACKGROUND OF THE INVENTION

1. Field of the Invention

The present invention relates to layout of images on pages or a display and particularly to an automatic optimal layout of images.

2. Description of the Prior Art

When laying out images on a space, typically to be printed or displayed on screen, it is often necessary to make a layout that maximizes the size of the images (thus minimizing the unfilled area), while keeping all the images the same size. It is typical in practical systems to also keep the images in a chosen order and to lay them on the page or the screen from left to right and top to bottom.

In a typical photographic situation, the user will have an ordered sequence of images with an arbitrary mixture of landscape and portrait oriented images, as shown in FIG. 1. It is also quite likely that the user manually crops images or assembles them into long thin panoramas. Accordingly, there may be an arbitrary mix of sizes and shapes among the images to be laid out.

Computer programs that print out images typically offer two general classes of options when laying out multiple images on printed pages:

a) Within the program, a large number of predefined templates are installed. The user selects a suitable template and then populates it with images.

b) Various options such as 2, 3, 4-per-page are selected. The program then divides the page and fits the images into the areas by adjusting their sizes.

When using template system a), the user is generally required to have all images in the same orientation, since it is not easy to provide optimal individual templates for all the possible layouts. Assuming an arbitrary sequence of portrait and landscape images, for two-per-page, there are 4 possible layouts. The number of the possible layouts increases exponentially with the number of images (for n-per-page there are n\hat{ }2 possible templates). It is not practical to have all the possible layouts installed in the computer for every combination of the images to be laid out.

Using the divide and fit scheme (b), the page is usually divided in equal segments. Considerable scaling of the images is often necessary to make them fit into the divided space, which results in a very uneven layout such as the layout of the images shown in FIGS. 2A and 2B. Furthermore, some page divisions are difficult, such as 5-per page, and tend to result in significantly non-optimal solutions.

Better layouts for the images in FIG. 2 are shown in FIGS. 3A and 3B. The images are more evenly sized.

### SUMMARY OF THE INVENTION

The object of the present invention is to provide a method of layout optimization for images on a page or display. It eliminates the need for a large number of templates and automatically produce an optimal layout.

The present invention provides a method for laying out arbitrary images in a given space, wherein the images are in an order. The method comprises steps of implementing a binary search for an optimal scale factor applied to all the images, for which there is only one of a first and second layout of the images fit to the space and identified as an optimal layout, and placing on the space by the optimal layout the images to which the optimal scale factor is applied, wherein the first layout is generated by steps of (a)laying out the images one by one in the order of the images along a reference line on the space until any one of the images goes beyond the space to form a row, (b)laying out the rest of the images one by one in the order along a line extending from an edge of a first ordered image in the previous row until any one of the images goes beyond the space or overlaps the laid out images to form a next row, and (c)repeating step (b) until all the images are laid out, and the second layout is generated by steps of (d)laying out the images one by one in the order along the reference line on the space until any one of the images goes beyond the space to form a row, (e)laying out the rest of the images one by one in the order along a line extending from an edge of one of the images in the previous row and closest to the reference line until any one of the images goes beyond the space or overlaps the laid out images to form a next row, and (f)repeating step (e) until all the images are laid out.

### BRIEF DESCRIPTION OF THE DRAWINGS

The present invention will become more fully understood from the detailed description given hereinbelow and the accompanying drawings, given by way of illustration only and thus not intended to be limitative of the present invention.

FIG. 1 is a diagram showing an ordered sequence of images with an arbitrary mixture of landscape and portrait oriented images.

FIGS. 2A and 2B are diagrams showing a layout of images produced by a conventional layout method.

FIGS. 3A and 3B are diagrams showing an optimal layout of the images shown in FIG. 2.

FIG. 4 is a diagram showing a mathematical layout.

FIG. 5 is a diagram showing a layout in which the images are scaled such that they can fit in a single row along the top of the page according to one embodiment of the invention.

FIG. 6 is a diagram showing a typical example with the top edge layout lines shown according to one embodiment of the invention.

FIG. 7 is a diagram showing a test made to see if the image can be fitted in any position on a line that runs below each image above without overlapping any other images according to one embodiment of the invention.

FIG. 8 is a diagram showing a typical result of the fit test 1 according to one embodiment of the invention.

FIGS. 9A-9D are diagrams showing the results of the fit test 1 and 2 according to one embodiment of the invention.

FIG. 10 is a diagram showing a layout before justification according to one embodiment of the invention.

FIG. 11 is a diagram showing the images justified to the sides and evenly spaced in between after justification according to one embodiment of the invention.

FIG. 12 is a diagram showing a layout before and after diagonal alignment according to one embodiment of he invention.

FIG. 13 is a flowchart of a method for laying out arbitrary shape images in a given space according to one embodiment of the invention.

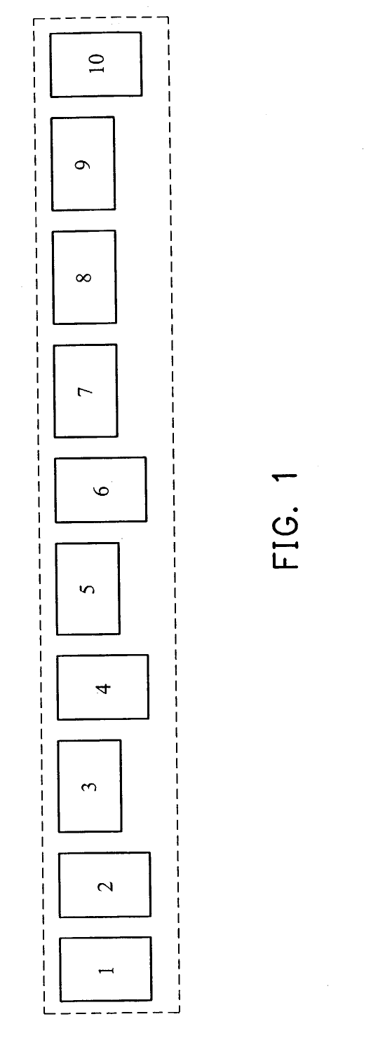

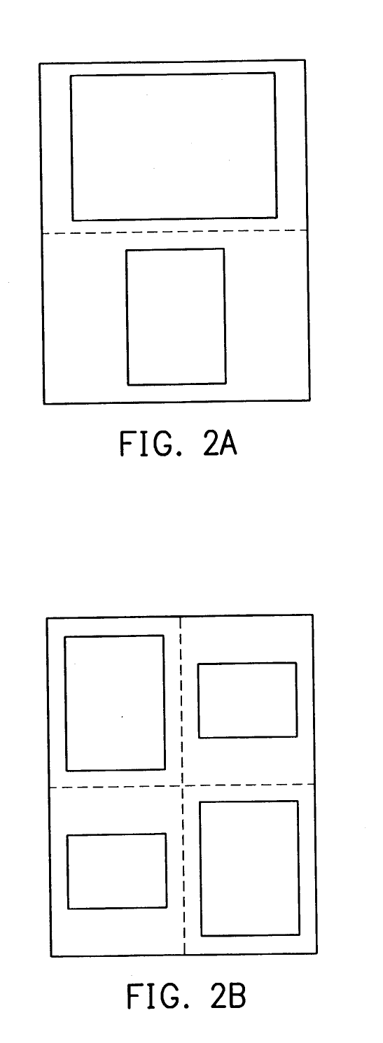

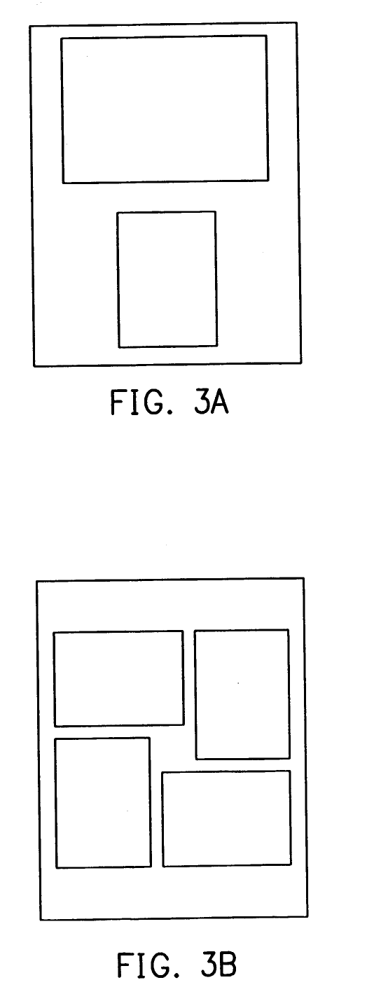

### DETAILED DESCRIPTION OF THE INVENTION

The preferred embodiment of the algorithm in the invention is in a computer program fitting images onto a sheet of paper for printing or into screen or window sizes for visual display.

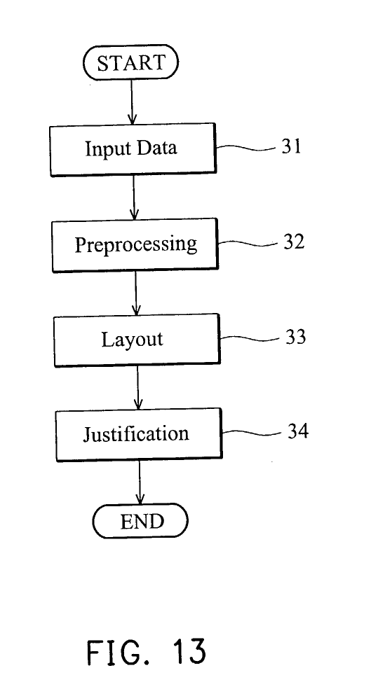

Processing follows the steps shown in FIG. 13:

Input Data (step 31): In the layout algorithm any arbitrary set of images can be processed. The images will be scaled up or down during the course of processing, but all by the same relative amount. In a practical system we also set a minimum separation between the images so that they are separated by some white space, the setting is chosen by the user according to taste and could be zero.

Optional Preprocessing Step (step 32): To improve the aesthetic appearance of the layout all the images can be set to have the same area (width*height). This tends to improve the fit and deal with the considerable resolution differences that can be present when images from different sources are used. Some images can be selected by the user as more (or less) important and can be set to a larger (or smaller) area than the other images.

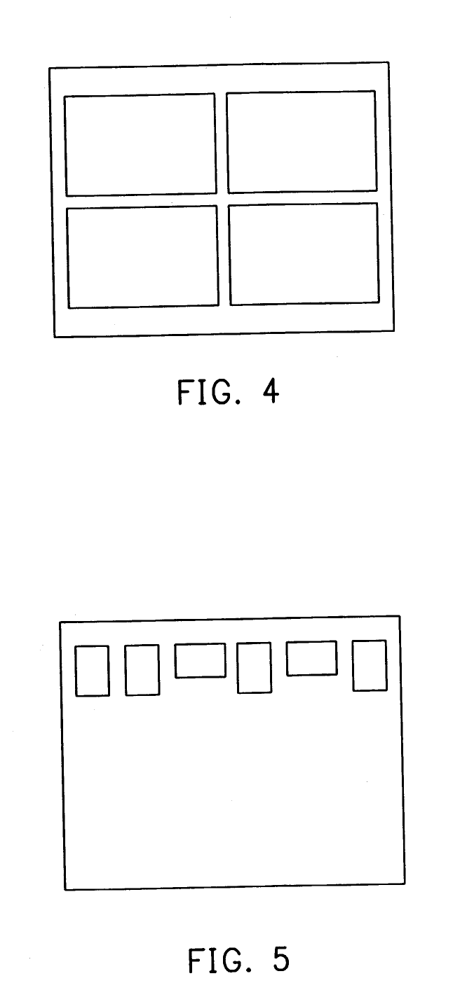

Test for Simple Cases: In practical systems it is quite likely that the images presented to the algorithm will all be the same size and aspect ratio. In certain simple cases no automatic layout is needed since simple mathematical layouts can be made, as shown in FIG. 4. Typical simple cases are where there are n images, x*y=n exists in integers and x, y are of similar magnitude.

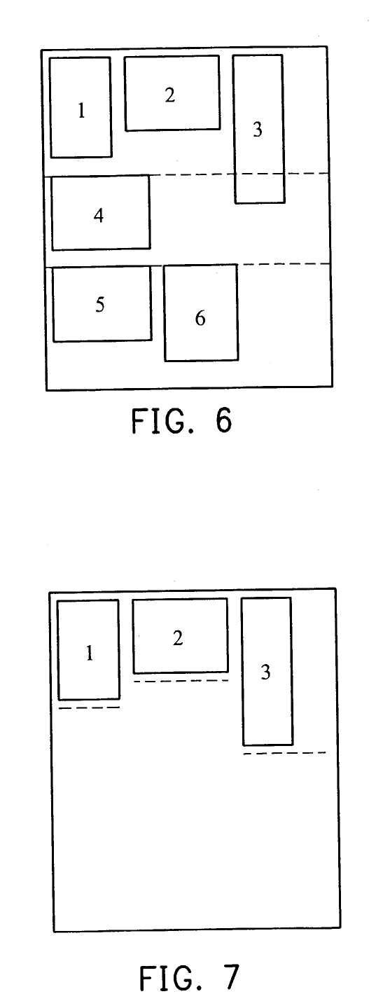

Layout Algorithm (step 33): The images will be scaled up and laid out on the paper until the largest scale factor is found for which the images can still be laid out. We know that a solution exists when all the images are scaled such that they can fit in a single row along the top of the page, as shown in FIG. 5. We also know that the layout will certainly fail when any image exceeds the size of the paper. This sets the upper and lower bound of the scaling factor. The algorithm then makes a binary search of scaling factors, testing whether layout is possible. The binary search is terminated when the desired level of accuracy is reached. The setting of the resolution is critical to balancing algorithmic efficiency with accuracy. The value wille be normally be set based on the resolution of the target display or printing system.

Method for checking each scale factor: We need to determine if images can be fitted on the paper at a given scale factor without making an exhaustive search of all possible image layouts. We know users prefer left to right and top to bottom layout. To see if the images fit we try laying out the images in this way, however for geometrical reasons two different approaches need to be checked to see if either yields a solution at this scale factor:

Fit test method 1: Place the first image in the top left corner, lay out the following images along the top until no more will fit. Then move to a row that is just below the bottom of the first image of the previous row. Repeat until the images are all laid out (success), or any image overlaps the bottom edge of the paper (failure). FIG. 6 shows a typical example with the top edge layout lines shown.

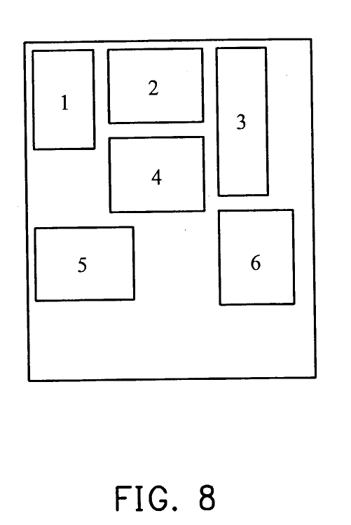

Fit test method 2: The first line is laid out as in ‘Fit test method 1’ above. On subsequent lines a test is made to see if the image can be fitted in any position on a line that runs below each image above without overlapping any other images as shown in FIG. 7. Where there are multiple possible locations the one closest to the top of the page is chose. FIG. 8 shows a typical result of this process.

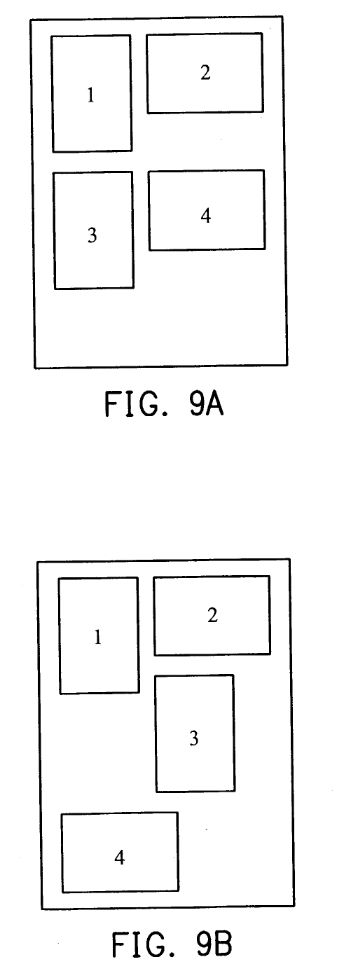

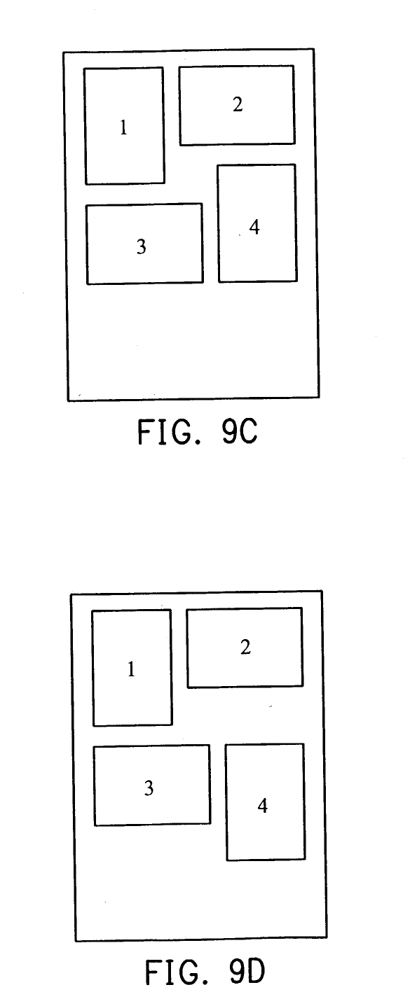

It may appear that ‘Fit test method 2’ would always give the optimal result, however this is not always the case. Optimal layout in FIG. 9A is only possible using method 1 (FIG. 9B shows the result using method 2). On the other hand FIG. 9C shows an arrangement that can only be achieved by the method 2 (FIG. 9D shows the failed case of method 1)

Justification(step 34). The algorithm described above will find an optimal layout for the images, the result is always justified to the top-left corner of the page. Other justification possibilities, right, centered, and filled (evenly spaced) can be derived from the basic layout by repositioning the images. Since the rows can interlock, repositioning algorithms have to associate images that are dependent and reposition them together. Since justification can occur both horizontally and vertically an additional diagonal layout is possible. To achieve these layouts multi-pass iterative algorithms are used to juggle the images into the optimal locations.

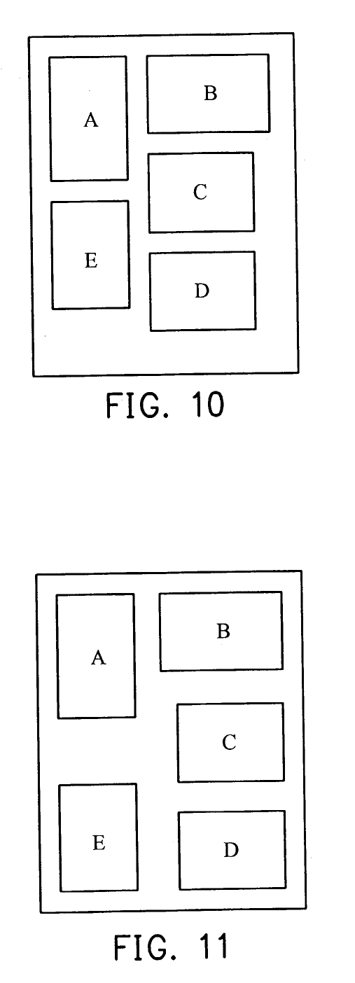

A typical result is shown in FIG. 10. For aesthetic reasons it is better to align images to the sides or center of the page in both horizontal and vertical directions. There are various possible justifications for images on a sheet of paper; in a similar manner to characters on a line of text, the images can be laid out with right, left and center alignment. Images can also be justified to the sides and evenly spaced in between as shown in FIG. 11.

The alignment or justified cases can be derived from the initial layout of the images on the page. A process is applied that moves the images to new locations on the page by shuffling them around while maintaining required separation and avoiding overlap. Unlike a line of text this is a two dimensional processes and vertical and horizontal alignment interact. These problems were solved as follows:

(a) As an image is moved toward center or right alignment it will tend to run into images on the left.

Each image should be examined in turn for possible left movement in turn, it should be moved to a better alignment if possible and if it does not run into other images or the edge. This process is iterated until it is not possible to improve the layout. Since possible image locations are quantized (since the are digitally represented) some bi-stable states can exist and need to be caught by limiting the number iterations.

(b) Both vertical and horizontal alignment can interact but only one kind is tried at one time. Vertical and horizontal alignment processes should be iteratively repeated until no further improvement is possible.

(c) In a practical implementation only horizontal alignment and justification need to be implemented since the ‘paper’ can be rotated on its top-left to bottom-right axis by switching X and Y coordinates. The same function is then reapplied. This simplifies the implementation complexity.

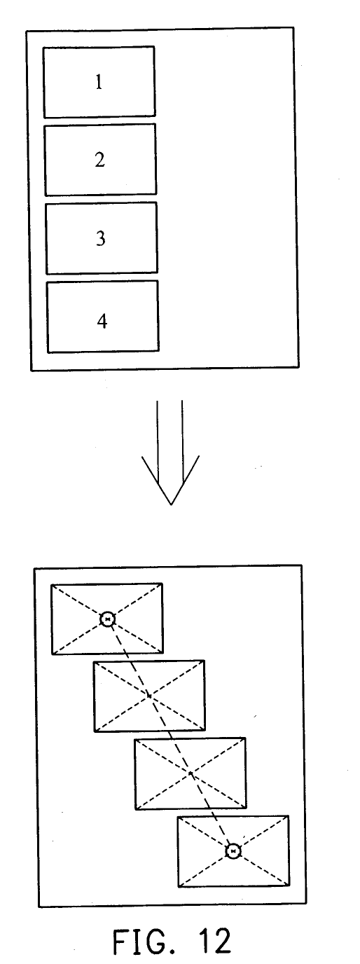

(d) Diagonal alignment is possible and gives quite a pleasing result as shown in FIG. 12.

The best looking alignment is probably one where the first image is aligned to the top left corner and the last image is aligned bottom left. The images between have their centers aligned on an axis between the centers of the first and last images. They are also evenly distributed on this line. To make this alignment processes are applied to try to iteratively move the images towards the ideal locations until the best solution is found. To reduce the computational complexity for simple cases (like the one above) the possibility of a mathematically derived layout can be detected and applied.

In conclusion, the present invention provides a method of layout optimization for images on a page or display. It utilizes an algorithm that efficiently implements the fitting process without a brute force search of the solution space and in most practical cases will find an optimal ordered layout. It also eliminates the need for a large number of templates in the conventional method.

The foregoing description of the preferred embodiments of this invention has been presented for purposes of illustration and description. Obvious modifications or variations are possible in light of the above teaching. The embodiments were chosen and described to provide the best illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

What is claimed is:

1. A method for laying out arbitrary shape images in a given space, wherein the images are in an order, the method comprising steps of:
implementing a binary search for an optimal scale factor applied to all the images, for which there is only one of a first and second layout of the images fit to the space and identified as an optimal layout; and
placement on the space of the images to which the optimal scale factor is applied by the optimal layout;
wherein the first layout is generated by steps of:
(1a)laying out the images one by one in the order along a reference line on the space until any one of the images goes beyond the space to form a row;
(1b)laying out the rest of the images one by one in the order along a line extending from an edge of a first ordered image in the previous row until any one of the iamges goes beyond the space or overlaps the laid out images to form a next row; and
(1c)repeating step (1b) until all the images are laid out; and
the second layout is generated by steps of:
(2a)laying out the images one by one in the order along the reference line on the space until any one of the images goes beyond the space to form a row;
(2b)laying out the rest of the iamges one by one in the order along a line extending from an edge of one of the iamges in the previous row and closest to the reference line until any one of the iamges goes beyond the space or overlaps the laid out images to form a next row; and
(2c)repeating step (2b) until all the iamges are laid out.

2. The method as claimed in claim 1 further comprising determination of lower and upper limits of the scale factor for the binary search.

3. The method as claimed in claim 1 further comprising setting the images to have the same area.

4. The method as claimed in claim 1 further comprising setting the images to have different areas according to importance of the images.

5. The method as claimed in claim 1 wherein there is fixed spacing between the images.

6. The method as claimed in claim 1 further comprising steps of:
interlocking the rows in the optimal layout; and
repositioning the images associated by the interlocking of the rows together.

7. The method as claimed in claim 6, wherein the images are justified to the right of the space by the repositioning.

8. The method as claimed in claim 6, wherein the images are justified to the center of the space by the repositioning.

9. The method as claimed in claim 6, wherein the images are evenly spaced on the space by the repositioning.

10. The method as claimed in claim 6, wherein the images are diagonally aligned in the space by the repositioning

11. The method as claimed in claim 1, wherein the images are suitable for printing on paper.

12. The method as claimed in claim 1, wherein the images are suitable for showing on a display or window.

13. The method as claimed in claim 1, wherein the reference line is a top edge of the space.

14. The method as claimed in claim 1, wherein the edges of the images from which the line extends in steps (1b) and (2b) are bottom edges of the images.

15. The method as claimed in claim 1, wherein the images are rectangular.
